(19) United States
(12) Patent Application Publication
(10) Pub. No.: US 2024/0019877 A1
(43) Pub. Date: Jan. 18, 2024

(54) FOLLOWING CONTROL METHOD FOR ROBOT, ELECTRONIC DEVICE, AND STORAGE MEDIUM

(71) Applicant: Beijing Xiaomi Robot Technology Co., Ltd., Beijing (CN)

(72) Inventor: Dongfang LI, Beijing (CN)

(21) Appl. No.: 18/085,469

(22) Filed: Dec. 20, 2022

(30) Foreign Application Priority Data
Jul. 18, 2022 (CN) 202210845997.5

(51) Int. Cl. G05D 1/12; G05D 1/00; G05D 1/02

(52) U.S. Cl. CPC G05D 1/12; G05D 1/0094; G05D 1/0223; G05D 1/0246

(57) ABSTRACT

A following control method for a robot includes: controlling the robot to follow a target object; in a process of following the target object, acquiring a relative pose relationship between the target object and the robot; and adjusting a visual field range of the robot according to the relative pose relationship and visual field parameter information of the robot, in which the target object is located in the adjusted visual field range. A relative angle with a visual field center line may be used to adjust a visual field range. An electronic device for controlling the robot is also disclosed.

### CROSS-REFERENCE TO RELATED APPLICATIONS

The present application claims the benefit of priority to Chinese Patent Application Serial No. 202210845997.5, filed on Jul. 18, 2022, the contents of which are incorporated herein by reference in their entireties for all purposes.

### BACKGROUND

Robots are increasingly used to perform a variety of tasks in daily work and life. Some robots are designed as following robots, where the motion of the robot is based on following another object. These types of robots are widely applied to the fields of logistics, motion accompaniment, photographing, shooting, recording and other fields.

### SUMMARY

The present disclosure relates to the field of robot technologies, and particularly to a following control method, an electronic device, and a storage medium.

According to a first aspect of embodiments of the present disclosure, a following control method for a robot is provided, including: controlling the robot to follow a target object; in the process of following the target object, acquiring a relative pose relationship between the target object and the robot; and adjusting a visual field range of the robot according to the relative pose relationship and visual field parameter information of the robot, in which the target object is located in the adjusted visual field range.

According to a second aspect of embodiments of the present disclosure, an electronic device is provided, including: at least one processor; and a memory communicatively connected with the at least one processor, in which the memory stores instructions executable by the at least one processor, and the instructions are executed by the at least one processor to implement a following control method for a robot according to embodiments of the first aspect of the present disclosure.

According to a third aspect of embodiments of the present disclosure, a non-transitory computer-readable storage medium having computer instructions stored thereon is provided, in which the computer instructions are configured to implement a following control method for a robot according to embodiments of the first aspect of the present disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure, and do not constitute an improper limitation of the present disclosure.

FIG. 1 is a flowchart of a following control method for a robot according to an embodiment.

FIG. 2 is a schematic diagram showing motion control of a robot according to a motion track of a target object in an embodiment.

FIG. 3 is a schematic diagram showing adjustment of a visual field range of a robot according to a motion track of a target object in an embodiment.

FIG. 4 is a schematic diagram in which a robot follows a target object from left rear in an embodiment.

FIG. 5 is a schematic diagram in which a robot follows a target object from right rear in an embodiment.

FIG. 6 is a flowchart of a following control method for a robot according to an embodiment.

FIG. 7 is an overall flow chart of a following control method for a robot according to an embodiment.

FIG. 8 is a schematic diagram of a following control apparatus for a robot according to an embodiment.

FIG. 9 is a block diagram of an electronic device for controlling a robot according to an embodiment.

### DETAILED DESCRIPTION

In order to make those skilled in the art better understand the technical solutions of the present disclosure, the technical solutions in embodiments of the present disclosure will be clearly and completely described below with reference to the accompanying drawings.

It should be noted that the terms “first”, “second”, or the like, in the description and claims of the present disclosure and in the foregoing, drawings are used for distinguishing between similar objects and not necessarily for describing a particular sequential or chronological order. It should be understood that data thus used is interchangeable in proper circumstances, such that embodiments of the present disclosure described herein can be implemented in orders except the orders illustrated or described herein. The implementations described in the following embodiments do not represent all implementations consistent with the disclosure. Instead, they are merely examples of an apparatus and a method consistent with some aspects related to the disclosure as recited in the appended claims.

In a process of tracking a target object by the robot, due to a mounting position of a sensor and a limitation of an effective visual field, if the target object deviates from an original route quickly, the target object disappears in the visual field of the robot, and the robot cannot continuously and effectively detect a pose of the target object, resulting in failure of a following task.

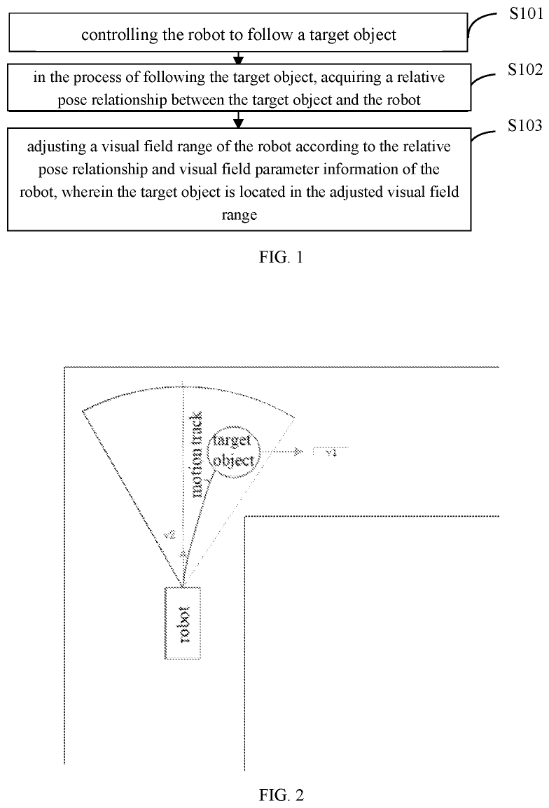

FIG. 1 is an implementation of a following control method for a robot according to the present disclosure, and as illustrated in FIG. 1, the following control method for a robot includes the following steps:

At block S101: the robot is controlled to follow a target object.

In a mobile robot application, 3 coordinate values are required in a plane to determine a unique state: two of the coordinates (X, Y) are used to determine a robot position and the other one is used to determine a robot orientation. Omnidirectional motion refers to a capability of the robot to move from a current position in any direction on a two-dimensional plane, and the robot with an omnidirectional motion capability can achieve a perfect motion performance, that is, can move along a path in any direction at the current position.

The robot according to the present disclosure has an omnidirectional motion capability; for example, the robot according to the present disclosure may include a quadruped robot having an omnidirectional motion capability, an unmanned aerial vehicle having an omnidirectional motion capability, or the like, and when the robot performs a following task, the robot is required to be controlled to follow a target object. The present disclosure can be suitable for a robot with a target following requirement, such as a service robot, a transfer robot, a motion accompanying robot, a photographing, shooting and recording robot, or the like.

For example, in a process of controlling the robot to follow the target object, motion control of the robot is mostly planned according to a motion track of the target object, and a right ahead direction of the robot is always along a tangential direction of the motion track of the target object in the motion process. FIG. 2 is a schematic diagram showing motion control of a robot according to a motion track of a target object in an embodiment, and as illustrated in FIG. 2, a circle represents the target object, a rectangle represents the robot, a curve is the motion track (illustrated in the drawing) of the target object, the target object turns to the right at a speed v1, the robot runs along a tangential direction of the motion track of the target object at a speed v2 to follow the target object, a sector represents a visual field range of an image capturing apparatus of the robot, a dotted line in the middle of the sector represents a visual field center line of the robot, and at this point, the target object is located in the visual field range of the robot. In some examples, the image capturing apparatus of the robot may include a camera, a depth camera, or the like, mounted on the robot.

At block S102: in the process of following the target object, a relative pose relationship between the target object and the robot is acquired.

In the process of following the target object, a real-time pose of the target object is acquired as a first pose, a real-time pose of the robot is acquired as a second pose, and the relative pose relationship between the target object and the robot is acquired based on the first pose of the target object and the second pose of the robot. The pose describes a position and a posture of the target object or the robot in a specified coordinate system, the position refers to a location of the target object or the robot in a space, and the posture refers to an orientation of the target object or the robot in the space.

For example, when the first pose of the robot is acquired, the first pose of the target object may be acquired by performing recognition and processing according to a real-time image of the target object captured by the robot, and when the second pose of the robot is acquired, the position of the robot may be acquired using a global navigation satellite system (GNSS), or active positioning may be performed based on communication technologies such as Wifi®, Bluetooth®, ultra wide band (UWB), or the like, to acquire the second pose of the robot.

At block S103: a visual field range of the robot is adjusted according to the relative pose relationship and visual field parameter information of the robot, in which the target object is located in the adjusted visual field range.

In the process that the robot follows the target object, if the target object suddenly and rapidly moves, the target object may disappear in the visual field range of the robot, and in order to prevent the target object from disappearing in the visual field range of the robot, the visual field range of the robot is required to be adjusted in real time according to the relative pose relationship between the target object and the robot and the visual field parameter information of the robot, such that the target object is always located in the adjusted visual field range. The visual field parameter information includes information, such as a visual field angle, a visual field center line, or the like, of the robot.

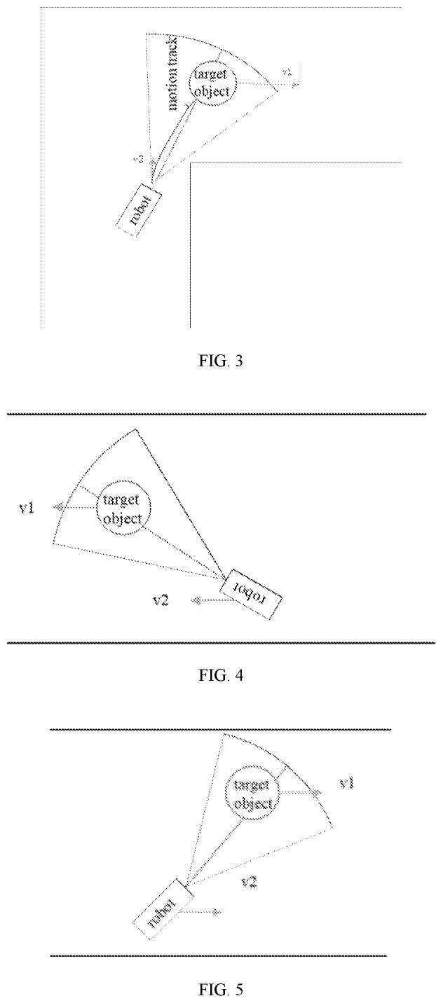

FIG. 3 is a schematic diagram of adjustment of the visual field range of the robot according to the motion track of the target object, and as illustrated in FIG. 3, in a process that the target object rapidly moves to the right at a corner, if the visual field range of the robot is still an original visual field range, the target object may disappear in the visual field range of the robot, and in FIG. 3, in the process that the robot moves along the tangential direction of the motion track of the target object, the robot is controlled to rotate to the right by a certain angle, such that the target object is also in the adjusted visual field range in the process of rapidly movement to the right. It should be noted that, since the robot according to the present disclosure has an omnidirectional motion capability, although the orientation of the robot is changed, the traveling direction of the robot is still along the tangential direction of the motion track of the target object. In some examples, when the robot is controlled to rotate to the right, the whole robot or only the image capturing apparatus of the robot is controlled to rotate to the right.

The embodiments of the present disclosure provides a following control method for a robot, the robot is controlled to follow the target object; in the process of following the target object, the relative pose relationship between the target object and the robot is acquired; and the visual field range of the robot is adjusted according to the relative pose relationship and visual field parameter information of the robot, in which the target object is located in the adjusted visual field range. In the present disclosure, under a condition that the visual field of the robot is limited, the visual field range of the robot is adjusted in real time according to the relative pose relationship between the target object and the robot, to prevent the target object from disappearing in the visual field range, thereby achieving an effect that the robot smoothly follows the target object.

Further, when the robot is controlled to follow the target object, in order to more accurately acquire the motion track of the target object, the real-time image of the target object can be acquired based on the image capturing apparatus mounted on the robot, and the motion track of the target object can be acquired according to the real-time image, such that the robot is controlled to follow the target object according to the motion track. In some examples, when the motion track of the target object is acquired according to the real-time image, a method of fitting according to historical track points, or the like, may be adopted.

As an implementation, in a rear following scenario, a preset relative distance between the target object and the robot is acquired, a first real-time speed of the target object is acquired in real time, a second real-time speed of the robot is acquired according to the first real-time speed and the preset relative distance, and after the second real-time speed of the robot is acquired, the robot is controlled to follow the target object at the second real-time speed along the tangential direction of the motion track, to avoid a situation that the robot cannot follow the target object due to a sudden increase of the speed of the target object, or a situation that the robot and the target object collide due to a sudden decrease of the speed of the target object. In the process of following the target object, the relative pose relationship between the target object and the robot is acquired, and the visual field range of the robot is adjusted according to the relative pose relationship between the target object and the robot and the visual field parameter information of the robot; the target object is located in the adjusted visual field range, such that the target object does not disappear in the visual field range of the robot in the rear following scenario.

For example, if initial moving speeds of the target object and the robot are both 5 km/h, the preset relative distance between the target object and the robot is 100 cm, if at a certain moment, the first real-time speed of the target object is suddenly increased to 8 km/h, in order to avoid the situation that the robot cannot follow the target object, the second real-time speed of the robot is acquired according to the first real-time speed of 8 km/h of the target object and the preset relative distance of 100 cm between the target object and the robot, and after the second real-time speed of the robot is acquired, the robot is controlled to follow the target object at the second real-time speed along the tangential direction of the motion track.

As another implementation, in a side following scenario, the robot is not required to run along the tangential direction of the track of the target object, and is required to run by keeping the preset relative pose relationship with the target object, the preset relative pose relationship between the target object and the robot is acquired, the robot is controlled to follow the target object according to the preset relative pose relationship, and in the following process, a first real-time motion direction of the robot and a second real-time motion direction of the target object are kept the same. In the process of following the target object, the relative pose relationship between the target object and the robot is acquired, and the visual field range of the robot is adjusted according to the relative pose relationship between the target object and the robot and the visual field parameter information of the robot; the target object is located in the adjusted visual field range, such that the target object does not disappear in the visual field range of the robot in the side following scenario.

FIG. 4 is a schematic diagram in which the robot follows the target object from left rear in the present disclosure, and as illustrated in FIG. 4, the direction of the robot is rotated by a certain angle, such that the target object is always located in the visual field range of the robot, the target object horizontally advances to the left at a speed v1, and the robot horizontally advances to the left at a speed v2. The speed v1 of the target object and the speed v2 of the robot may be the same or different.

FIG. 5 is a schematic diagram in which the robot follows the target object from right rear in the present disclosure, and as illustrated in FIG. 5, the direction of the robot is rotated by a certain angle, such that the target object is always located in the visual field range of the robot, the target object horizontally advances to the right at a speed v1, and the robot horizontally advances to the right at a speed v2. The speed v1 of the target object and the speed v2 of the robot may be the same or different.

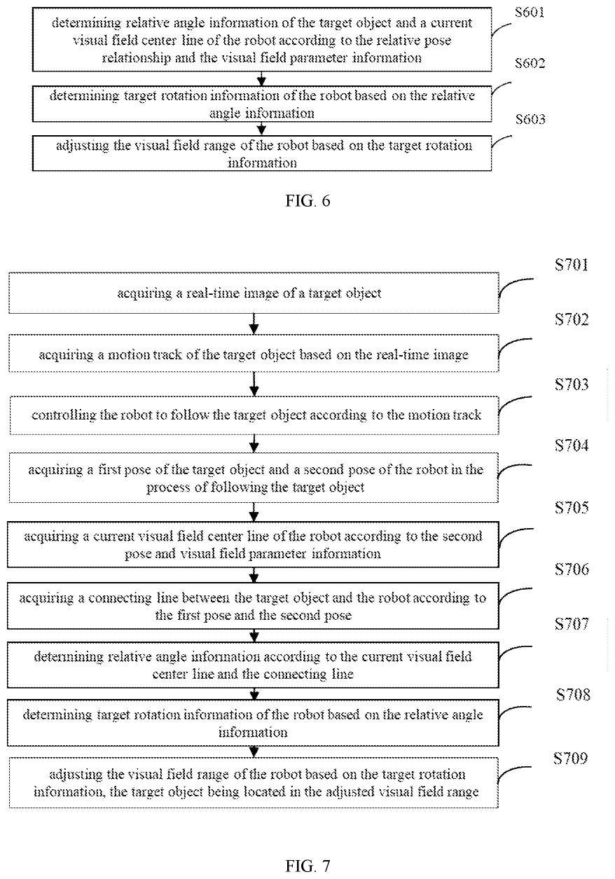

FIG. 6 is an implementation of the following control method for a robot according to the present disclosure, and as illustrated in FIG. 6, based on the foregoing embodiment, adjusting a visual field range of the robot according to the relative pose relationship and visual field parameter information of the robot includes the following steps:

At block S601: relative angle information of the target object and a current visual field center line of the robot is determined according to the relative pose relationship and the visual field parameter information.

In the process of following the target object, the real-time pose of the target object is acquired as the first pose, the real-time pose of the robot is acquired as the second pose, and the relative pose relationship between the target object and the robot is acquired according to the first pose of the target object and the second pose of the robot.

The current visual field center line of the robot is acquired according to the second pose and the visual field parameter information of the robot, a connecting line between the target object and the robot is acquired according to the first pose of the target object and the second pose of the robot, a magnitude and a direction of an angle formed by the current visual field center line and the connecting line are acquired, and the magnitude and the direction of the angle are taken as the relative angle information. For example, if the connecting line between the target object and the robot is located on the right side of the current visual field center line of the robot, and the angle formed by the current visual field center line and the connecting line is 30°, the relative angle information of the target object relative to the current visual field center line of the robot is a right angle of 30°. It should be noted that, in order to conveniently acquire the relative angle information between the target object and the current visual field center line of the robot, one end of the connecting line between the target object and the robot is located at the target object, and the other end is located at an emission vertex of the current visual field center line of the robot, which can also be regarded as the position of the image capturing apparatus.

At block S602: target rotation information of the robot is determined based on the relative angle information.

The target rotation information of the robot is determined according to the determined relative angle information of the target object relative to the current visual field center line of the robot.

As an implementation, the relative angle information may be directly used as the target rotation information of the robot; for example, if the determined relative angle information of the target object relative to the current visual field center line of the robot is a right angle of 30°, the target rotation information of the robot is rightward rotation by 30°.

As another implementation, a preset angle threshold may be preset, and if the relative angle information is greater than the preset angle threshold, it is considered that the target object is at risk of disappearing from the visual field range at this point, and the relative angle information is determined as the target rotation information of the robot. For example, if the visual field range of the robot is 120°, the visual field range of the robot may be regarded as a range of 60° on the left side and a range of 60° on the right side of the current visual field center line, and if the preset angle threshold is set to 40°, which means that when the relative angle information is greater than 40°, it is considered that the target object is at risk of disappearing from the visual field range at this point, the relative angle information is determined as the target rotation information of the robot. For example, when the relative angle information is 45° on the right side, rightward rotation by 45° is used as the target rotation information of the robot. The target rotation information of the robot is determined to be preset rotation information if the relative angle information is less than or equal to the preset angle threshold. The preset rotation information may be 0; that is, when the relative angle information is less than or equal to the preset angle threshold, it is considered that the target object is not at risk of disappearing from the visual field range at this point, and the visual field range of the robot is not adjusted.

At block S603: the visual field range of the robot is adjusted based on the target rotation information.

The visual field range of the robot is adjusted according to the determined target rotation information.

For example, if the determined target rotation information is rightward rotation by the robot is controlled to rightwards rotate by 30°, to adjust the visual field range of the robot.

In embodiments of the present disclosure, under the condition that the visual field of the robot is limited, the visual field range of the robot is adjusted in real time according to the relative pose relationship between the target object and the robot, to prevent the target object from disappearing in the visual field range, thereby achieving the effect that the robot smoothly follows the target object.

FIG. 7 is an overall flow chart of a following control method for a robot according to the present disclosure, and as illustrated in FIG. 7, the following control method for a robot includes the following steps:

At block S701: a real-time image of a target object is acquired.

At block S702: a motion track of the target object is acquired based on the real-time image.

At block S703: the robot is controlled to follow the target object according to the motion track.

For implementations of steps S701 to S703, reference may be made to the description of relevant parts in the above embodiments, and details are not repeated herein.

At block S704: a first pose of the target object and a second pose of the robot are acquired in the process of following the target object.

At block S705: a current visual field center line of the robot is acquired according to the second pose and visual field parameter information.

At block S706: a connecting line between the target object and the robot is acquired according to the first pose and the second pose.

At block S707: relative angle information is determined according to the current visual field center line and the connecting line.

For implementations of steps S704 to S707, reference may be made to the description of relevant parts in the above embodiments, and details are not repeated herein.

At block S708: target rotation information of the robot is determined based on the relative angle information.

At block S709: the visual field range of the robot is adjusted based on the target rotation information, the target object being located in the adjusted visual field range.

For implementations of steps S708 to S709, reference may be made to the description of relevant parts in the above embodiments, and details are not repeated herein.

The embodiments of the present disclosure provide the following control method for a robot, the robot is controlled to follow the target object; in the process of following the target object, the relative pose relationship between the target object and the robot is acquired; and adjusting the visual field range of the robot is adjusted according to the relative pose relationship and visual field parameter information of the robot, in which the target object is located in the adjusted visual field range. In the present disclosure, under the condition that the visual field of the robot is limited, the visual field range of the robot is adjusted in real time according to the relative pose relationship between the target object and the robot, to prevent the target object from disappearing in the visual field range, thereby achieving the effect that the robot smoothly follows the target object.

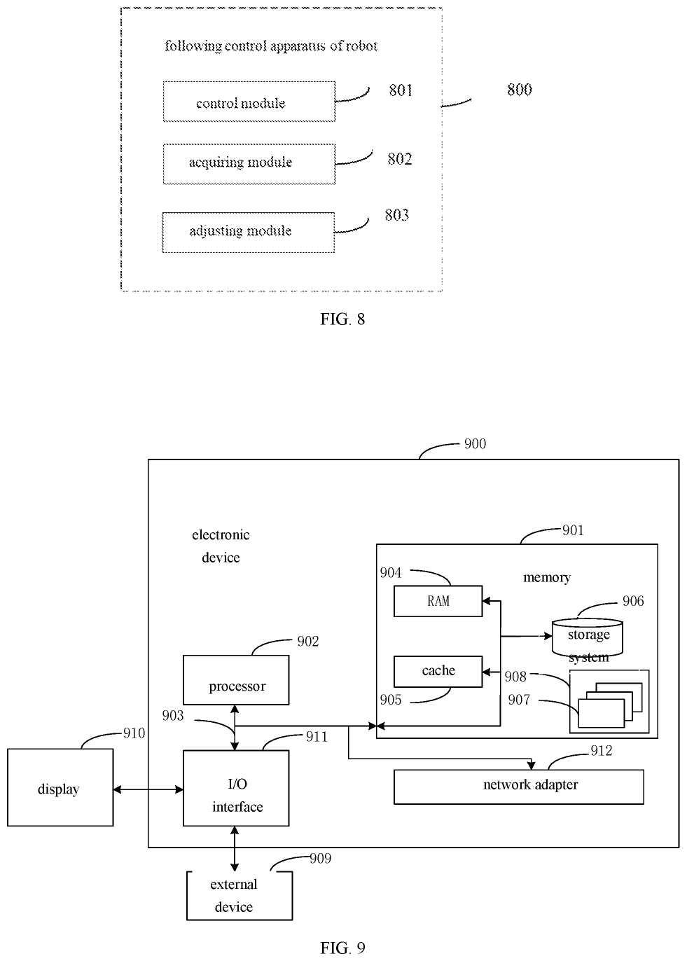

FIG. 8 is a schematic diagram of a following control apparatus for a robot according to the present disclosure, and as illustrated in FIG. 8, the following control apparatus 800 for a robot includes a control module 801, an acquiring module 802, and an adjusting module 803.

The control module 801 is configured to control the robot to follow a target object.

The acquiring module 802 is configured to, in the process of following the target object, acquire a relative pose relationship between the target object and the robot.

The adjusting module 803 is configured to adjust a visual field range of the robot according to the relative pose relationship and visual field parameter information of the robot, in which the target object is located in the adjusted visual field range.

The embodiments of the present disclosure provide the following control apparatus for a robot, the robot is controlled to follow the target object; in the process of following the target object, the relative pose relationship between the target object and the robot is acquired; and the visual field range of the robot is adjusted according to the relative pose relationship and visual field parameter information of the robot, in which the target object is located in the adjusted visual field range. In the present disclosure, under the condition that the visual field of the robot is limited, the visual field range of the robot is adjusted in real time according to the relative pose relationship between the target object and the robot, to prevent the target object from disappearing in the visual field range, thereby achieving the effect that the robot smoothly follows the target object.

Further, the adjusting module 803 is further configured to: determine relative angle information of the target object and a current visual field center line of the robot according to the relative pose relationship and the visual field parameter information; determine target rotation information of the robot based on the relative angle information; and adjust the visual field range of the robot based on the target rotation information.

Further, the adjusting module 803 is further configured to: acquire the current visual field center line of the robot according to a second pose and the visual field parameter information; acquire a connecting line between the target object and the robot according to a first pose and the second pose; and determine the relative angle information according to the current visual field center line and the connecting line.

Further, the adjusting module 803 is further configured to: determine the relative angle information as the target rotation information of the robot in response to the relative angle information being greater than a preset angle threshold. The target rotation information of the robot is determined to be preset rotation information in response to the relative angle information being less than or equal to the preset angle threshold.

Further, the control module 801 is further configured to: acquire a real-time image of the target object; acquire a motion track of the target object based on the real-time image; and control the robot to follow the target object according to the motion track.

Further, the control module 801 is further configured to: acquire a preset relative distance between the target object and the robot in a rear following scenario; acquire a first real-time speed of the target object, and acquire a second real-time speed of the robot according to the first real-time speed and the preset relative distance; and control the robot to follow the target object along a tangential direction of the motion track at the second real-time speed.

Further, the control module 801 is further configured to: acquire a preset relative pose relationship between the target object and the robot in a side following scenario; and control the robot to follow the target object according to the preset relative pose relationship, a first real-time motion direction of the robot and a second real-time motion direction of the target object being kept the same.

FIG. 9 is a block diagram of an electronic device 900 according to an embodiment.

As illustrated in FIG. 9, the electronic device 900 includes:
a memory 901, a processor 902, and a bus 903 connecting different components (including the memory 901 and the processor 902). The memory 901 stores a computer program, and the processor 902 executes the program to implement the following control method for a robot according to embodiments of the present disclosure.

The bus 903 represents one or more of several types of bus structures, including a memory bus or memory controller, a peripheral bus, an accelerated graphics port, a processor or a local bus using any of a variety of bus structures. By way of example, such architectures include, but are not limited to, an industry standard architecture (ISA) bus, a micro channel architecture (MAC) bus, an enhanced ISA bus, a video electronics standards association (VESA) local bus, and a peripheral component interconnection (PCI) bus.

The electronic device 900 typically includes a variety of electronic device readable medium. Such medium may be any available medium which is accessible by the electronic device 900, and include both volatile and non-volatile medium, and removable and non-removable medium.

The memory 901 may further include a computer system readable medium in the form of a volatile memory, such as a random access memory (RAM) 904 and/or a cache memory 905. The electronic device 900 may further include other removable/non-removable, volatile/non-volatile computer system storage medium. By way of example only, a storage system 906 may be provided for reading from and writing to a non-removable, non-volatile magnetic medium (not illustrated in FIG. 9 and typically called a “hard drive”). Although not illustrated in FIG. 9, a magnetic disk drive for reading from and writing to a removable, non-volatile magnetic disk (e.g., a “floppy disk”), and an optical disk drive for reading from or writing to a removable, non-volatile optical disk (such as a CD-ROM, a DVD-ROM or other optical medium) may be provided. In such instances, each drive may be connected with the bus 903 through one or more data medium interfaces. The memory 901 may include at least one program product having a set (e.g., at least one) of program modules which are configured to carry out the functions of embodiments of the present disclosure.

A program/utility 908 having a set (at least one) of program modules 907 may be stored in the memory 901 by way of example, and such program modules 907 include, but are not limited to, an operating system, one or more application programs, other program modules, and program data. Each of these examples or a certain combination thereof might include an implementation of a networking environment. The program modules 907 generally carry out the functions and/or methodologies of embodiments of the present disclosure.

The electronic device 900 may also be communicated with one or more external devices 909 (such as a keyboard, a pointing device, a display 910, etc.); with one or more devices which enable a user to interact with the electronic device 900; and/or with any device (e.g., a network card, a modem, etc.) which enables the electronic device 900 to be communicated with one or more other computing devices. Such communication may occur via input/output (I/O) interfaces 911. In addition, the electronic device 900 may further be communicated with one or more networks (such as a local area network (LAN), a wide area network (WAN), and/or a public network (e.g., the Internet)) via a network adapter 912. As illustrated in FIG. 9, the network adapter 912 is communicated with other modules of the electronic device 900 via the bus 903. It should be understood that although not illustrated in FIG. 9, other hardware and/or software modules may be used in conjunction with the electronic device 900, and include, but are not limited to: microcodes, device drives, redundant processing units, external disk drive arrays, RAID systems, tape drives, data backup storage systems, etc.

The processor 902 executes various function applications and data processing by running programs stored in the memory 901.

It should be noted that, for the implementation process and the technical principle of the electronic device according to the embodiment, reference is made to the foregoing explanation of the following control method for a robot according to embodiments of the present disclosure, and details are not repeated herein.

In order to realize the above embodiments, embodiments of the present disclosure further provide a non-transitory computer-readable storage medium having computer instructions stored thereon, in which the computer instructions are used to cause a computer to implement the following control method for a robot according to the above embodiments. In some examples, the non-transitory computer-readable storage medium may be a ROM, a random access memory (RAM), a CD-ROM, magnetic tape, a floppy disk, an optical data storage device, or the like.

In order to realize the above embodiments, embodiments of the present disclosure further provide a computer program product, which includes a computer program, the computer program, when executed by a processor, implementing the following control method for a robot according to the above embodiments.

In order to realize the above embodiments, embodiments of the present disclosure further provide a robot, including the following control apparatus for a robot according to the above embodiments or the electronic device according to the above embodiments.

Other embodiments of the disclosure will be apparent to those skilled in the art from consideration of the specification and practice of the invention disclosed here. This disclosure is intended to cover any variations, uses, or adaptations of the disclosure following the general principles of the present disclosure and including common knowledge or customary technical means in the art that is not disclosed in the present disclosure. The specification and embodiments are considered to be examples only, and the true scope and spirit of the disclosure are indicated by the following claims.

It will be understood that the disclosure is not limited to the precise structures described above and illustrated in the drawings, and that various modifications and changes may be made without departing from the scope thereof. The scope of the disclosure is limited only by the appended claims.

What is claimed is:

1. A following control method for a robot, comprising:
controlling, by an electric device, the robot to follow a target object;
in a process of following the target object, acquiring, by an electric device, a relative pose relationship between the target object and the robot; and
adjusting, by an electric device, a visual field range of the robot according to the relative pose relationship and visual field parameter information of the robot, wherein the target object is located in the adjusted visual field range.

2. The method according to claim 1, wherein adjusting, by an electric device, a visual field range of the robot according to the relative pose relationship and visual field parameter information of the robot comprises:
determining, by an electric device, relative angle information of the target object and a current visual field center line of the robot according to the relative pose relationship and the visual field parameter information;
determining, by an electric device, target rotation information of the robot based on the relative angle information; and
adjusting, by an electric device, the visual field range of the robot based on the target rotation information.

3. The method according to claim 2, wherein the relative pose relationship comprises a first pose of the target object and a second pose of the robot, and determining, by an electric device, relative angle information of the target object and a current visual field center line of the robot according to the relative pose relationship and the visual field parameter information comprises:
acquiring, by an electric device, the current visual field center line of the robot according to the second pose and the visual field parameter information;
acquiring, by an electric device, a connecting line between the target object and the robot according to the first pose and the second pose; and
determining, by an electric device, the relative angle information according to the current visual field center line and the connecting line.

4. The method according to claim 2, wherein determining, by an electric device, target rotation information of the robot based on the relative angle information comprises:
determining, by an electric device, the relative angle information as the target rotation information of the robot in response to the relative angle information being greater than a preset angle threshold; and
determining, by an electric device, the target rotation information of the robot to be preset rotation information in response to the relative angle information being less than or equal to the preset angle threshold.

5. The method according to claim 1, wherein controlling, by an electric device, the robot to follow a target object comprises:
acquiring, by an electric device, a real-time image of the target object;
acquiring, by an electric device, a motion track of the target object based on the real-time image; and
controlling, by an electric device, the robot to follow the target object according to the motion track.

6. The method according to claim 5, wherein controlling, by an electric device, the robot to follow the target object according to the motion track comprises:
acquiring, by an electric device, a preset relative distance between the target object and the robot in a rear following scenario;
acquiring, by an electric device, a first real-time speed of the target object, and acquiring, by an electric device, a second real-time speed of the robot according to the first real-time speed and the preset relative distance; and
controlling, by an electric device, the robot to follow the target object along a tangential direction of the motion track at the second real-time speed.

7. The method according to claim 1, wherein controlling, by an electric device, the robot to follow a target object comprises:
acquiring, by an electric device, a preset relative pose relationship between the target object and the robot in a side following scenario; and
controlling, by an electric device, the robot to follow the target object according to the preset relative pose relationship, a first real-time motion direction of the robot and a second real-time motion direction of the target object being kept the same.

8. An electronic device for controlling a robot, comprising:
a processor; and
a memory communicatively connected with the processor,
wherein the memory is configured to store instructions executable by the processor, and the processor is configured to:
control the robot to follow a target object;
in a process of following the target object, acquire a relative pose relationship between the target object and the robot; and
adjust a visual field range of the robot according to the relative pose relationship and visual field parameter information of the robot, wherein the target object is located in the adjusted visual field range.

9. The electronic device according to claim 8, wherein the processor is configured to:
determine relative angle information of the target object and a current visual field center line of the robot according to the relative pose relationship and the visual field parameter information;
determine target rotation information of the robot based on the relative angle information; and
adjust the visual field range of the robot based on the target rotation information.

10. The electronic device according to claim 9, wherein the relative pose relationship comprises a first pose of the target object and a second pose of the robot, and the processor is configured to:
acquire the current visual field center line of the robot according to the second pose and the visual field parameter information;
acquire a connecting line between the target object and the robot according to the first pose and the second pose; and
determine the relative angle information according to the current visual field center line and the connecting line.

11. The electronic device according to claim 9, wherein the processor is configured to:
determine the relative angle information as the target rotation information of the robot in response to the relative angle information being greater than a preset angle threshold; and
determine the target rotation information of the robot to be preset rotation information in response to the relative angle information being less than or equal to the preset angle threshold.

12. The electronic device according to claim 8, wherein the processor is configured to:
acquire a real-time image of the target object;
acquire a motion track of the target object based on the real-time image; and
control the robot to follow the target object according to the motion track.

13. The electronic device according to claim 12, wherein the processor is configured to:
acquire a preset relative distance between the target object and the robot in a rear following scenario;
acquire a first real-time speed of the target object, and acquire a second real-time speed of the robot according to the first real-time speed and the preset relative distance; and
control the robot to follow the target object along a tangential direction of the motion track at the second real-time speed.

14. The electronic device according to claim 8, wherein the processor is configured to:
acquire a preset relative pose relationship between the target object and the robot in a side following scenario; and
control the robot to follow the target object according to the preset relative pose relationship, a first real-time motion direction of the robot and a second real-time motion direction of the target object being kept the same.

15. A non-transitory computer-readable storage medium having computer instructions stored thereon, wherein the computer instructions are configured to cause a computer to perform a following control method for a robot, comprising:
controlling the robot to follow a target object;
in a process of following the target object, acquiring a relative pose relationship between the target object and the robot; and
adjusting a visual field range of the robot according to the relative pose relationship and visual field parameter information of the robot, wherein the target object is located in the adjusted visual field range.

16. The storage medium according to claim 15, wherein adjusting a visual field range of the robot according to the relative pose relationship and visual field parameter information of the robot comprises:
determining relative angle information of the target object and a current visual field center line of the robot according to the relative pose relationship and the visual field parameter information;
determining target rotation information of the robot based on the relative angle information; and
adjusting the visual field range of the robot based on the target rotation information.

17. The storage medium according to claim 16, wherein the relative pose relationship comprises a first pose of the target object and a second pose of the robot, and determining relative angle information of the target object and a current visual field center line of the robot according to the relative pose relationship and the visual field parameter information comprises:
acquiring the current visual field center line of the robot according to the second pose and the visual field parameter information;
acquiring a connecting line between the target object and the robot according to the first pose and the second pose; and
determining the relative angle information according to the current visual field center line and the connecting line.

18. The storage medium according to claim 16, wherein determining target rotation information of the robot based on the relative angle information comprises:
determining the relative angle information as the target rotation information of the robot in response to the relative angle information being greater than a preset angle threshold; and
determining the target rotation information of the robot to be preset rotation information in response to the relative angle information being less than or equal to the preset angle threshold.

19. The storage medium according to claim 15, wherein controlling the robot to follow a target object comprises:
acquiring a real-time image of the target object;
acquiring a motion track of the target object based on the real-time image; and
controlling the robot to follow the target object according to the motion track.

20. The storage medium according to claim 19, wherein controlling the robot to follow the target object according to the motion track comprises:
acquiring a preset relative distance between the target object and the robot in a rear following scenario;
acquiring a first real-time speed of the target object, and acquiring a second real-time speed of the robot according to the first real-time speed and the preset relative distance; and
controlling the robot to follow the target object along a tangential direction of the motion track at the second real-time speed.
